(19) United States
(12) Patent Application Publication
(10) Pub. No.: US 2007/0211649 A1
(43) Pub. Date: Sep. 13, 2007

(54) Automatic establishment of a network connection for automated network element configuration

(75) Inventors: Markus Hauenstein, Dusseldorf (DE); Andreas Wannenwetsch, Dusseldorf (DE)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/657,102

(22) Filed: Jan. 24, 2007

(30) Foreign Application Priority Data
Jan. 27, 2006 (EP) 06001748.0

(51) Int. Cl. H04L 12/28

(52) U.S. Cl. 370/254

(57) ABSTRACT

The invention relates to a simplified way to configure a new network element in a 3G radio access network. According to the invention, a network element, which requires connectivity to another external network element, automatically performs probing a connection in order to establish a connection to a network management system or the like.

### BACKGROUND OF THE INVENTION

1. Field of the Invention

The invention relates to a network element and a method for configuring the network element, and in particular to an automatic establishment of a network connection for automated commissioning and/or recovery of network elements.

2. Description of the Related Art

Heretofore, it is necessary to perform commissioning of network elements such as e.g. Base Transceiver Stations (BTS) or Base Stations in cellular radio access networks manually. That is, a visit of e.g. a BTS site is usually required during network rollout after the BTS installation, in order to perform commissioning tasks. But also in the normal operation phase, site visits are sometimes necessary when the remote management connection has been lost for some reason, e.g. because of an unintended misconfiguration leading to the breakup of the DCN (data communication network used for remote management of the network elements) connection, or because of a software malfunction.

The commissioning of a new BTS must currently be done locally at the BTS site because the BTS has initially no DCN connectivity. These site visits are expensive and time-consuming.

After installation, recovery/maintenance actions for the BTS may have to be carried out on site. For example, because of some wrong remote configuration action, a BTS might get screwed up and loose its DCN connection, requiring then a site visit in order to restore the planned settings and so the DCN connection.

The commissioning of a new network element and recovery/maintenance of an existing network element has to be done on site, because no configuration file or the like can be downloaded to the network element since it has no network connectivity.

Thus, commissioning of a new network element, such as a BTS, and recovery/maintenance of an existing network element, such as a BTS, involves considerable work on site and, thus, high costs.

### SUMMARY OF THE INVENTION

Hence, it is an object of the present invention to solve the problem mentioned above and to provide a network element and a method by which commissioning and recovery/maintenance can be simplified.

According to several embodiments of the present invention, this object is solved by a network element, which requires connectivity to another external network element, comprising configuration unit configured to automatically configure a connection by probing different connection settings.

Alternatively, according to several embodiments of the invention, the above object is solved by a method for configuring a network element, which requires connectivity to another external network element, comprising configuring a connection by automatically probing different connection settings.

Hence, according to several embodiments of the present invention it is possible to start a configuration of a network element such as a BTS automatically. That is, the presence of skilled maintenance personnel on site is not necessary.

Thus, since now no skilled maintenance personnel, which is able to do on-site commissioning or reconfiguration as according to the prior art, is necessary, a reduction of such site visits is possible. This can reduce the operator's OPEX (operational expenditure) considerably.

Moreover, according to several embodiments of the present invention, in detail the following may be carried out upon configuring the network element: selecting a connection setting, using the connection setting via an interface of the network element, and deciding, based on a failure/success indication of the interface, whether the connection setting is usable or not.

The connection to be probed may be a connection on a physical layer. Then, in case the failure/success indication from the interface indicates a failure, it is decided that the connection setting is not usable. However, if the failure/success indication indicates success (this may be an indication that no longer failure messages are sent), it is decided that the connection setting is usable.

The connection to be probed may be a data link connection. Then, the connection settings may comprise asynchronous transfer mode (ATM) and/or inverse multiplexing over ATM (IMA).

Furthermore, an address may be borrowed from a connected upstream network element in order to use it as the address of the network element to be configured.

According to a further aspect of the invention, the above object is solved by a network element, which requires connectivity to another external network element in order to receive certain configuration information, comprising a configuration unit which is configured to borrow an address from a connected upstream network element in order to use it as the address of the network element to be configured.

The invention also proposes a network element for configuring a network element connected downstream, which requires connectivity to another external network element in order to receive certain configuration information, comprising a configuration unit which is adapted to lend an address to the connected downstream network element.

Moreover, according to several embodiments of the invention, the above object is solved by a method for configuring a network element, which requires connectivity to another external network element in order to receive certain configuration information, comprising the step of borrowing an address from a connected upstream network element in order to use it as the address of the network element to be configured.

Alternatively, according to several embodiments of the invention, a method for configuring a network element connected downstream, which requires connectivity to another external network element in order to receive certain configuration information, comprises the step of lending an address to the connected downstream network element.

In this way, connectivity for the network element to be configured can easily be achieved. Then, a configuration file or the like can easily be loaded to the network element to be configured since it now has an address.

Hence, similar as described above, the process of commissioning or recovery/maintenance of a network element is simplified.

Preferably, an address from the subnet of the upstream BTS is lent to the network element to be configured. In this way, it can be avoided to update routing tables of intermediate routers in order to be aware of the new network element, which would be necessary in case only a new IP address would be assigned. If such a subnet address is lent, this is not needed, because all IP packets addressed to the new network element in the subnet are automatically routed to the upstream BTS “owning” the subnet.

Moreover, the borrowing of the address may be performed by using a dynamic host configuration protocol (DHCP) client functionality in the network element to be configured. The lending of the address may be performed by using by using a dynamic host configuration protocol (DHCP) server functionality in the network element connected upstream.

Furthermore, only one address may be available for lending or borrowing from the subnet address space. This further simplifies the process.

The network element to be configured may be a base station in a cellular network, and also the network element connected upstream of the network element to be configured may be a base station or a radio network controller (RNC) in a cellular network.

The procedure according to the present invention may be carried out in order to receive certain configuration information using the connectivity. Such certain configuration information may comprise a configuration file, which can be downloaded by using the lending address described above.

The invention also proposes a network, and a program for carrying out the steps of the invention.

### BRIEF DESCRIPTION OF THE DRAWINGS

The invention is described by referring to the enclosed drawings, in which:

FIG. 1A shows a basic flow chart of probing a layer-1 and/or layer-2 connection according to the an embodiment of the present invention,

FIG. 1B shows a basic flow chart of borrowing an IP address from an upstream BTS according to the embodiment, and

FIGS. 2A and 2B show a hierarchical topology of a plurality of base stations including a base station to be commissioned in accordance with the embodiment.

### DETAILED DESCRIPTION OF THE PREFERRED EMBODIMENT

In the following, a preferred embodiment of the present invention is described by referring to the attached drawings.

As described above, the invention relates to a simplified way how to configure a new network element in a network, e.g. in a 3G radio access network. According to the present invention, a new installed network element (e.g. a BTS) connects automatically to the network management system or a dedicated server in order to download its configuration from there.

In the following, several steps how this connection is established are described in connection with the preferred embodiment of the invention in the following.

According to this embodiment, a BTS is used as an example for a network element to be configured.

The prerequisite for automated BTS commissioning is IP connectivity. This means, that layer-1 (physical layer), layer-2 (IP data link layer) and layer-3 (IP layer) must all be operational. According to the preferred embodiment described in the following, this can be accomplished. In particular, according to the embodiment, the following processes are carried out:
Probing (i.e. trying out) of different layer-1 and layer-2 settings, and

usage of a lending address (i.e., the lent or borrowed address) so that the new unconfigured downstream BTS temporarily becomes a member of the upstream BTS subnet. Due to the lent subnet address the new BTS is directly reachable in the network without any update of routing information in the network.

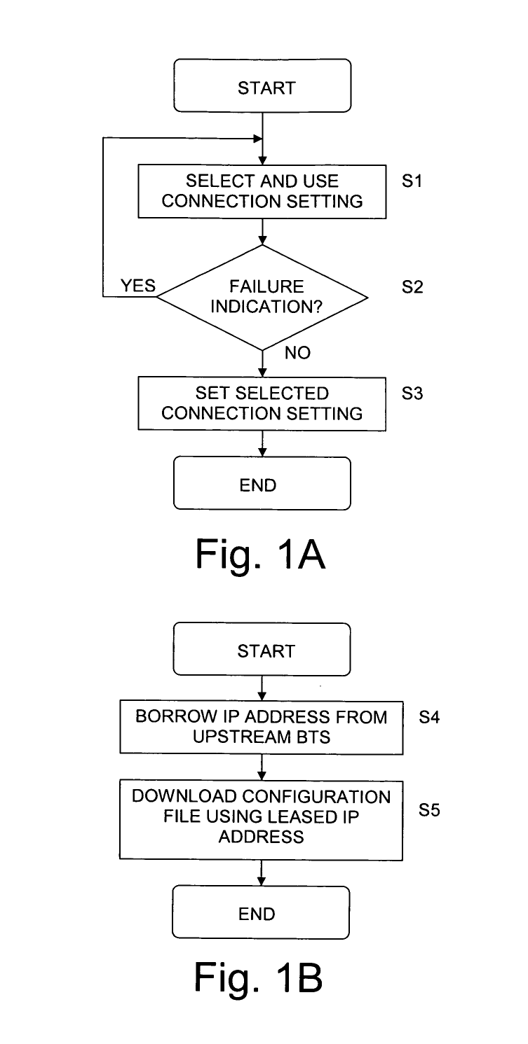

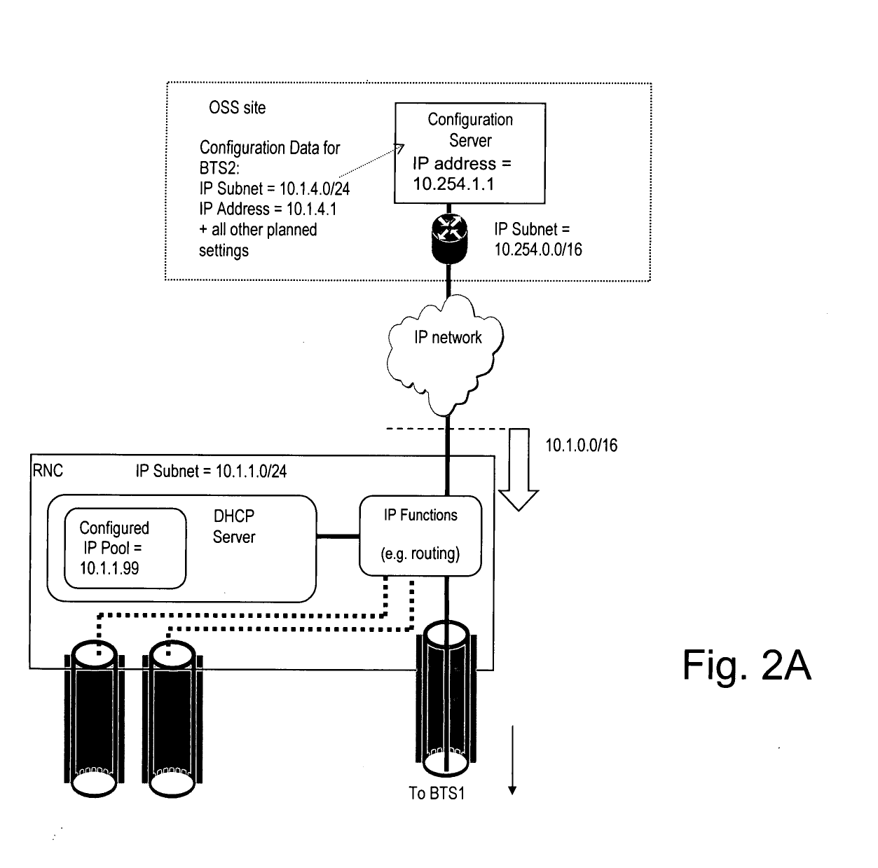

This is illustrated in FIGS. 1A and 1B in a very general form:

In FIG. 1A the probing of different layer-1 or layer-2 connection is shown. In step S1, a connection setting is selected and actually used, i.e., tried or probed. In step S2, it is checked whether there are failure indications or not. If a failure indication is present (YES), it is decided that the connection setting does not work and the process returns to step S1 in order to try another connection setting. In case no failure indication is present (NO in step S2), it is decided that the connection setting works, and this connection setting is set as the operational connection setting of the network element (e.g., BTS).

After successfully carrying out the process of FIG. 1A for layer-1 and layer-2, the process shown in FIG. 1B may be carried out. In step S4, an IP address from an upstream network element (e.g., BTS) is borrowed, and in step S5, a configuration file can be downloaded, since now the BTS to be configured has an IP address.

Thus, no prior physical, data link or IP layer configuration in the new BTS is needed, not even an IP address. In case the BTS gets screwed-up because of some wrong remote configuration action, the BTS can recover by applying the same process or parts of the process again.

In the following, the implementation of the above-described processes according to the embodiment is described in more detail.

General

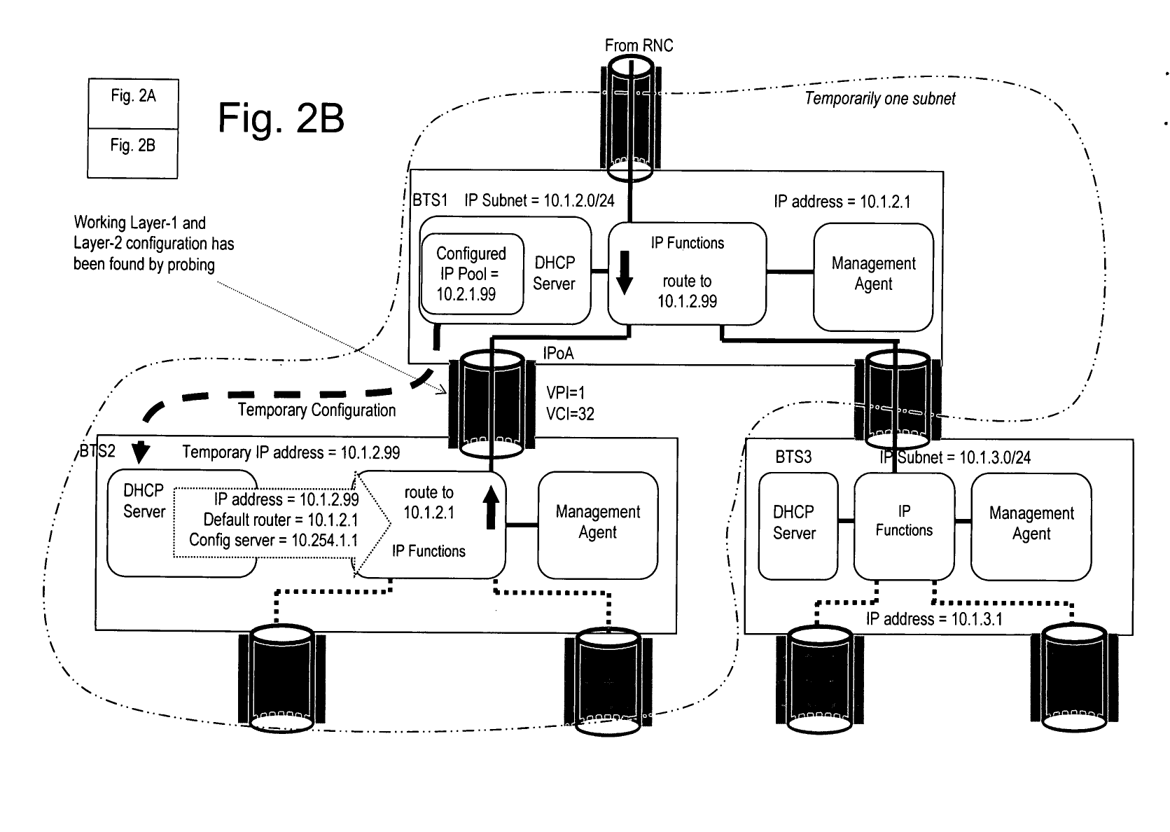

According to the present embodiment, a hierarchical topology as depicted in FIGS. 2A and 2B is assumed. When several base stations are commissioned with the process according to the present embodiment, this will be done in a top-down manner: The base stations directly connected to the RNC will be configured first. When these base stations are running with their planned configuration, the base stations immediately connected to them will be configured next, and so on.

In FIGS. 2A and 2B, it is assumed that a BTS2 is to be configured, whereas BTS1 is already configured. The further shown BTS3 is also already configured. BTS1 is on top in the hierarchy of the BTS2 and BTS3 and is connected to the radio network controller (RNC). The RNC acts as IP router and is connected via an IP network with the OSS (operating support system) site as shown in FIGS. 2A and 2B. In particular, the OSS site contains a configuration server which the BTSs can contact to download their planned configuration.

Moreover, each BTS in FIGS. 2A and 2B comprises a management agent, which serves to carry out the configuration processes as described below, and is an example for a configuration means of a network element. Further details of FIGS. 2A and 2B will be explained in the following.

Probing to get Physical and IMA Layer Connectivity

It is now assumed that there is a BTS running with its planned configuration. The interfaces towards downstream base stations are configured as planned. This means that physical, IMA (inverse multiplexing over ATM), ATM (asynchronous transfer mode) and IP layers are correctly configured here. But there is no communication yet via these interfaces, since there are no downstream base stations configured yet. For example, in FIGS. 2A and 2B, BTS1 is running with its planned configuration, whereas BTS2 is not yet configured.

It is assumed that cabling rules exist. The first interface of a downstream BTS shall always be connected to the upstream BTS. Then there is always a network path towards RNC and further on towards the core network. It can be assumed that a configuration server is located in the core network. With this cabling rule, it can be ensured that a not-configured BTS will always try to communicate with an already configured BTS, and not with a BTS even deeper in the hierarchy.

When cabling rules shall not be applied, more complicated algorithms are needed for detecting the physical interfaces leading in upstream direction towards the RNC. Such algorithms are not in the scope of this invention and therefore not discussed further here.

The first problem to be solved is physical layer connectivity, i.e., to configure the layer-1 connection (physical layer connection). Solution: The new base station probes different physical layer settings (e.g. E1 or T1, line codes, framing options) until a working configuration has been found (steps S1 and S2 of FIG. 1A). Since there are not so many reasonably configuration options and therefore not so many combinations of them, this is feasible. The correct set of physical layer settings is detected when physical layer alarms disappear (e.g. loss-of-signal, loss-of-frame, as examples for a failure indication) and the operational state of the physical interface is up (step S3 of FIG. 1A).

As next step, ATM cell transmission will start in order to configure the layer-2 connection (IP Data Link Layer connection). At this early stage, these are only special ATM cells. When an IMA group is configured, the configured base station will send IMA Control Protocol (ICP) cells and Filler cells. When no IMA group is configured, it will send idle cells. If OAM (service for operating, managing and maintaining networks) is configured, the upstream BTS will also send OAM cells. Since IMA and OAM are not yet configured in the new BTS, the new BTS will initially always send only idle cells. The loss-of-cell-delineation alarm (as an example for a failure indication) will disappear, and the interface specific transmission convergence sublayer will be operational on the physical interface.

The next problem for the new BTS is to find out whether IMA is configured or not. Monitoring the received ATM cells can theoretically do this. With IMA, the new BTS will receive ICP and Filler cells, without IMA not. Furthermore, when IMA is configured, all necessary information to set up a corresponding IMA group is already contained in the received ICP cells. In practical implementations, this information might however not be easily accessible, and it might not be possible to directly derive a working configuration from the received cells. As a solution to this problem, the probing approach can then again be applied to get IMA connectivity. This is explained in the next paragraph.

Preferably, the sufficient-links parameter in the already configured upstream base station is always set to 1. Then asymmetric IMA configurations are possible, i.e. the upstream BTS can have an IMA group with several physical links, and the new downstream BTS with just one link, as it is assumed. In principle, there could be many ways to select physical links and to bundle them to an IMA group. But with setting the Sufficient-Links parameter to 1 in the upstream BTS, the downstream BTS only needs to try out trivial IMA groups of size 1, i.e. consisting of a single link. And furthermore, with the above cabling rule, the downstream BTS does not need to try out all of its interfaces but only the first one.

On its first interface, the BTS can thus probe different IMA settings as e.g. IMA version and IMA frame length. When a working configuration of the IMA layer is found, the operational state of the IMA group will get up. Since the usage of IMA is however not mandatory, the new base station might not find a working IMA configuration when the upstream BTS does not use IMA. In this case the downstream BTS will assume an ATM configuration without IMA, and should nevertheless get connectivity via its first physical interface. After this phase, the downstream BTS has an operational ATM interface connecting it to the upstream BTS.

Fixed ATM and AAL5 Layer Configuration

It is now assumed that on this ATM interface a special VCC (virtual channel connection) is reserved for automatic configuration usage, e.g. always the VCC with VPI=1 and VCI=32 (VPI: virtual path identifier, VCI: virtual channel identifier). This VCC is intended for temporarily transporting the IP DCN traffic. So AAL5 (ATM adaptation layer 5) and LLC/SNAP (logical link control/subnetwork access protocol) encapsulation are always configured here. For the IP layer, the VCC is a point-to-point interface. Since the underlying AAL5, ATM, IMA and physical layers are now operable, this point-to-point interface leading to the upstream BTS is also operable and available for the IP layer.

Get an IP Address from the Upstream BTS Subnet

It is now assumed that each BTS has its own IP subnet and not only a single IP address. Thus, intermediate IP routers will have subnet routes instead of host specific routes and can route IP packets for all IP hosts in the subnet without requiring a routing table update.

In FIGS. 2A and 2B, BTS1 has the IP Subnet 10.1.2.0/24, and the IP address 10.1.2.1.

The basic idea is now that a new downstream BTS (e.g., BTS 2 in FIGS. 2A and 2B) borrows an IP address from the upstream BTS subnet and becomes temporarily a member of the subnet of the upstream BTS (steps S4 and S5 of FIG. 1B).

This can be done via DHCP (dynamic host configuration protocol). A base station must therefore implement both DHCP client (in case it acts as the new downstream BTS) and server (in case it acts as the already configured upstream BTS). The upstream BTS (e.g., BTS1 in FIGS. 2A and 2B) running with its planned configuration has an active DHCP server. The new downstream BTS (e.g., BTS2 in FIGS. 2A and 2B) has a DHCP client. The new BTS sends then a DHCP request via the temporary DCN channel, requesting IP configuration parameters. The DHCP server in the configured BTS receives this request. Exactly for this purpose, there is an IP address pool configured containing just one IP address (the “lending address”) from the internal subnet of the upstream BTS. In the example according to FIGS. 2A and 2B, this lending address of the IP address pool is 10.1.1.99.

This lending address is now granted (with a short lease time) to the new base station (if another new BTS appears, it will have to wait until the first one is commissioned and the IP address is released again). Also, the new BTS will have the same subnet mask as the configured BTS, and it will use the configured BTS as its default router (these parameters are also transmitted via DHCP). Effectively, the new BTS becomes thus a host in the configured base station's subnet. Both base stations run also InATMARP (inverse ATM address resolution protocol) on the DCN channel (because of LLC/SNAP encapsulation, InATMARP and IP packets can be differentiated), so their IP routing tables are automatically updated with host-specific direct routes to each other, in both cases pointing to the temporary DCN VCC.

Thus, the new BTS has now full IP connectivity to the IP DCN. Configuration download can therefore start. If the process takes longer, the DHCP client will renew its lease of the lending address via the temporary DCN channel.

It is noted that in case the topmost BTS in the hierarchy was to be configured (e.g., BTS1 in FIGS. 2A and 2B), then the upstream network element would be the RNC. As shown in FIGS. 2A and 2B, also the RNC contains the DHCP server functionality described above.

Download of Configuration File

The configuration file for the downstream BTS can be downloaded manually or automatically. The scenarios for this are manifold, and some examples are described in the following.

In the manual case, the upstream BTS may notify the management system about the new downstream BTS. This notification may contain:

Some identifier (e.g. serial number), which uniquely identifies the new downstream BTS. The downstream BTS has then passed this identifier to the upstream BTS before via some IP-based protocol.

The IP address of the new downstream BTS.

Topology information, i.e. the physical interface(s) of the upstream BTS at which the new downstream BTS appeared.

The management system can then select the correct configuration file for the new downstream BTS and download it remotely (no site visit required).

In an automatic scenario, the new downstream BTS will get the address of a configuration server from the upstream BTS (this may have been contained in the DHCP response). Using some IP-based protocol as FTP, the downstream BTS will then contact this server and download its specific configuration file. For example, the specific configuration file may be identified based on an identifier of the new BTS.

Application of Downloaded Configuration

The file containing the planned configuration having been downloaded, the new BTS will apply this configuration. Depending on the implementation, this might include a restart or not. After this, the IMA group in the downstream BTS will contain the planned number of links. Also, the downstream BTS will use its own planned IP address, which is contained in the configuration file, and no longer the lending address from the upstream BTS subnet. Because of InATMARP interaction, the upstream base station learns that the IP address on the other end has changed, and updates its routing table accordingly. Furthermore, the downstream base station might start its routing protocol (e.g. OSPF or IS-IS) and distribute reachability information to the IP DCN. After a while, the reachability information has traversed the whole DCN, and full IP connectivity of the downstream BTS with the planned IP address is established.

The lease of the lending address will expire in the upstream BTS at some point in time, and can again be used by another new base station connected to different interfaces.

The new formerly not-configured BTS is now running with its planned configuration, and it can now become an upstream BTS for new downstream base stations, which are located one level deeper in the network hierarchy.

BTS Recovery

Because of some wrong remote configuration action, a BTS may get screwed up and loose its DCN connection. By some means (e.g. keep-alive messages) the BTS may detect this. In order to regain the DCN connection and to restore a working configuration, the BTS may fall back into the not-commissioned state, and the whole process as described above may take place again. In this connection, it is noted that a chain reaction should be avoided: Because of the misconfiguration of some upstream BTS, the connected downstream base stations may also loose their DCN connection. These downstream BTS should then not fall back into the not-commissioned state.

An example for a detection mechanism in order to detect such a screwing up and loosing the DCN connection is described in the following:

The BTS pings a server in the OSS, e.g. every minute. When this works, the BTS assumes that its DCN configuration is correct. When this does not work (after a number of retries), the BTS enters the recovery state.

When there are layer-1 or layer-2 errors on the upstream interfaces (according to the cabling rules), probing is done to fix this. The configuration on the other interfaces and on layer-3 is not changed.

When layer-1 and layer-2 works again, the layer-1/layer-2 configuration before probing is tried out again, and if this works, this old configuration is used, otherwise the configuration found by probing is used. Thus, the configuration will not change, when a problem in the transmission network (e.g. a cable cut) leading to a temporary connection loss has been repaired. The BTS attempts to ping the server again. If this works, the current BTS configuration is not changed. If this does not work, address borrowing from the upstream BTS is done to regain DCN connectivity. The BTS can then ping the OSS server again, using the lending address. If this works now, the BTS can assume that its own IP configuration is corrupt. Using the lending address, the BTS can then send a notification to management requesting reconfiguration, or even download and apply the configuration file again.

When there are no layer-1 or layer-2 errors on the upstream interfaces (according to the cabling rules), address borrowing from the upstream BTS is directly done to regain DCN connectivity. When pinging the server with the lending address succeeds, the BTS can assume that its own IP configuration is corrupt and send a notification to management requesting reconfiguration, or even download and apply the configuration file again.

When pinging the server with the lending address does also not work, the BTS assumes that the problem is somewhere else in the network and keeps its IP configuration.

Further Notes

Concerning DHCP and automated commissioning, the RNC should have the same functionality as a configured BTS, so that unconfigured base stations can also be directly connected to the RNC.

DHCP is especially tailored for broadcast networks as Ethernet and not for the point-to-point structure as found in the RAN. DHCP software must be adapted to this environment.

Thus, as described above, by the automated configuration according to the present embodiment, the commissioning/recovery process of a BTS can be simplified, since it is not necessary to send correspondingly skilled personnel to the BTS site in order to configure the BTS on site. Thus, for an operator, automated configuration is a very beneficial feature, saving a lot of OPEX.

The invention is not limited to the embodiment described above, and various modifications are possible.

For example, the invention is not limited to specific protocols described above.

Instead of DHCP, some proprietary and lighter protocol might be used. This protocol might be based on SOAP/XML (simple object access protocol/extended markup language). A simple data exchange mechanism for the IP parameters is however not sufficient, since something equivalent to the DHCP address leasing mechanism is required.

Moreover, it is not always necessary to carry out all steps described above. For example, in the recovery case, as also described in the example for a detection mechanism to detect loosing the DCN connection, depending on the circumstances, layer 1 might be still configured correctly and only the steps for probing layer 2 settings are needed. On the other hand it might be even sufficient to carry out only then borrowing (or lending) of the temporary IP address, when for example only the IP settings are lost for some reason and the configuration file has to be downloaded again.

Furthermore, the BTS described in the above embodiment is only an example for a network element to be configured. However, any kind of network element which needs some kind of connectivity can be configured in the way as described above.

Moreover, according to the embodiment described above, the BTS as an example for a network element probes the connection in order to receive certain configuration information such as a configuration file. However, the network element may also be some kind of network element which only needs connectivity, so that no further configuration information is necessary. For example, such a network element may be some kind of simple network element only notifying alarms and/or sending reports and the like. Hence, it is only necessary for such a network element to send data and not to receive data. Therefore, it is not necessary to receive configuration files or the like.

1. A network element, which requires connectivity to another external network element, comprising:
a configuration unit configured to automatically configure a connection by probing different connection settings.

2. The network element according to claim 1, wherein the configuration unit is configured to select one of the connection settings, use the selected connection setting via an interface of the network element, and to decide, based on a failure/success indication of the interface, whether the selected connection setting is usable or not.

3. The network element according to claim 1, wherein the connection to be configured is a connection on a physical layer.

4. The network element according to claim 2, wherein the connection to be configured is a connection on a physical layer, and when the failure/success indication from the interface indicates a failure, the configuration means is configured to decide that the selected connection setting is not usable.

5. The network element according to claim 2, wherein the connection to be configured is a connection on a physical layer, and the configuration means is adapted to decide that the selected connection setting is usable in case the failure/success indication from the interface indicates a success.

6. The network element according to claim 1, wherein the connection to be probed is a data link connection.

7. The network element according to claim 6, wherein the different connection settings comprise asynchronous transfer mode (ATM) related connection settings.

8. The network element according to claim 7, wherein the different connection settings comprise inverse multiplexing over asynchronous transfer mode (IMA) related connection settings.

9. The network element according to claim 1, wherein the configuration unit is configured to borrow an address from a connected upstream network element in order to use it as the address of the network element to be configured.

10. The network element according to claim 9, wherein
the configuration unit is configured to take the borrowed address from the subnet of a connected upstream network element.

11. The network element according to claim 9, further comprising a dynamic host configuration protocol (DHCP) client functionality, which is configured to perform borrowing of the borrowed address from the connected upstream network element.

12. The network element according to claim 1, wherein the configuration unit is configured to receive certain configuration information using the connectivity.

13. The network element according to claim 9, wherein the configuration unit is configured to receive a configuration file, being the certain configuration information, by using the borrowed address.

14. The network element according to claim 1, comprising a plurality of interfaces, wherein a dedicated interface is provided for a connection to an upstream network element in order to perform the connection probing.

15. A network element for configuring a network element connected downstream via a point to point connection, which requires connectivity to another external network element in order to receive certain configuration information; comprising
a configuration unit which is configured to lend an address from its own subnet to the connected downstream network element to configure the downstream connected network element.

16. The network element according to claim 1, wherein the network element to be configured is a base station in cellular networks.

17. The network element according to claim 15, wherein the network element connected upstream of the network element to be configured is a base station or a radio network controller (RNC) in a cellular network.

18. A method for configuring a network element, which requires connectivity to another external network element, comprising
configuring a connection by automatically probing different connection settings.

19. The method according to claim 18, wherein the configuring comprises selecting a connection setting;
using the selected connection setting via an interface of the network element, and
deciding, based on a success/failure indication from the interface, whether a connection configuration is usable or not.

20. The method according to claim 19, wherein the connection to be configured is a connection on a physical layer.

21. The method according to claim 20, wherein the connection to be configured is a connection on a physical layer and when the failure/success indication from the interface indicates a failure, it is decided in the deciding step that the connection setting is not usable.

22. The method according to claim 20, wherein the connection to be configured is a connection on a physical layer, and in the deciding step, it is decided that the connection setting is usable in case the failure/success indication from the interface indicates a success.

23. The method according to claim 19, wherein the connection to be configured is a data link connection.

24. The method according to claim 23, wherein the connection settings comprise asynchronous transfer mode (ATM) related connection settings.

25. The method according to claim 23, wherein the connection settings comprise Inverse Multiplexing over Asynchronous transfer mode (IMA) related connection settings.

26. The method according to claim 18, further comprising
borrowing an address from a connected upstream network element in order to use it as the address of the network element to be configured.

27. The method according to claim 26, wherein
in the borrowing, the address is taken from a network element subnet.

28. The method according to claim 26, wherein the borrowing is performed by using a dynamic host configuration protocol (DHCP) client functionality.

29. The method according to claim 26, further comprising
receiving certain configuration information using the connectivity.

30. The method according to claim 26, further comprising
receiving a configuration file by using the borrowed address.

31. A method for configuring a network element connected downstream via a point to point connection, which requires connectivity to another external network element in order to receive certain configuration information, comprising
lending an address from its own subnet to the connected downstream network element.

32. The method according to claim 18, wherein the network element to be configured is a base station in a cellular network.

33. The method according to claim 31, wherein the network element connected upstream of the network element to be configured is a base station or a radio network controller in a cellular network.

34. A communication system comprising:
a first network element having a configuration unit that automatically configures a connection by probing different connection settings; and
a second network element connected upstream of the first network element to be configured.

35. The communication system according to claim 34, wherein the first network element to be configured is a base station in a cellular network.

36. The system according to claim 34, wherein the second network element connected upstream of the first network element to be configured is a base station or a radio network controller in a cellular network.

37. A computer program embodied on a computer readable medium, that when executed by a computer, controls a configuration process for configuring a network element, which requires connectivity to another external network element, comprising:
configuring a connection by automatically probing different connection settings.

38. A computer program according to claim 37 comprising:
borrowing an address from the subnet of a connected upstream network element, connected via a point to point connection, in order to use it as an address of the network element to be configured.

39. A network element, which requires connectivity to another external network element, comprising:
means for automatically configuring a connection by probing different connection settings.

40. A network element for configuring a network element connected downstream via a point to point connection, which requires connectivity to another external network element in order to receive certain configuration information; comprising
means for lending an address from its own subnet to the connected downstream network element to configure the downstream connected network element.
